(19) United States
(12) Patent Application Publication
(10) Pub. No.: US 2003/0001371 A1
(43) Pub. Date: Jan. 2, 2003

(54) Gas supply line for an airbag module

(76) Inventors: Thilo Wackenroder, Eppstein (DE); Matthias Volkmann, Kronberg (DE)

Correspondence Address: BREED AUTOMOTIVE TECHNOLOGY, INC, 5300 ALLEN K BREED HIGHWAY, P O BOX 33050, LAKELAND, FL, 33807-3050, US

(21) Appl. No.: 09/988,638

(22) Filed: Nov. 20, 2001

(30) Foreign Application Priority Data
Jun. 28, 2001 (DE) 10131286.5

(51) Int. Cl. B60R 21/28

(52) U.S. Cl. 280/742

(57) ABSTRACT

A gas supply line for an airbag module connects a source of inflation gas to an airbag. Located inside of the gas supply line is at least one flow-directing element, which creates a twist in a linear flow of gas through the gas supply line. A source of inflation gas can be located inside of the gas supply line.

### FIELD OF THE INVENTION

The present invention relates to a gas supply line for an airbag module.

### BACKGROUND OF THE INVENTION

Airbag modules have two main components, an airbag and a source of inflation gas. Due to the spatial arrangement in a motor vehicle, it is not always possible to arrange the airbag directly on the source of inflation gas. This concerns in particular side curtain airbag modules wherein an airbag in its inflated state extends in the vehicle from the lateral roof beam essentially over the entire vehicle side. In these airbag modules, the source of inflation gas is generally arranged in the region of a column C of the vehicle or in the roof region of the motor vehicle. A gas supply line extends from the source of inflation gas to the airbag. In a crash the source of inflation gas is activated and gas flows a relatively long distance from the source of inflation gas to the airbag via the gas supply line. To compensate for this, gas supply lines with a relatively large cross section need to be used with a side curtain airbags.

A gas supply line for an airbag module according to the invention is used to connect a source of inflation gas with an airbag of a curtain airbag module. The gas supply line is preferably the shape of a tube or hose. At least one flow-directing ridge is arranged inside of the gas supply line to act in a flow-directing manner upon a gas, which flows in essentially the longitudinal direction, i.e. linearly through the gas supply line. The ridge is flow-directing in such a manner that a twist is created in the flow, i.e. in addition to its linear movement, the flow also undergoes a rotational movement. This twist causes an improved laminar flow with less turbulence in the gas supply line. This is particularly valid for the regions of the gas supply line in which cross section changes are required, for instance due to connecting pieces. Overall thus, a significantly lower flow resistance in the gas supply line can be achieved. This ensures a more rapid flow or a higher gas flow rate in the gas supply line, so that an airbag can be more rapidly inflated with gas. For this reason, the overall required gas volume may be reduced. In addition this enables the use of smaller sources of inflation gas, which is an advantage with regard to spatial relations in a motor vehicle and for reasons of cost. Since the airbag is more rapidly filled or inflated due to the more rapid gas flow and its lower flow resistance through the gas supply line, the required protective effect for a vehicle occupant can also be ensured sooner. It is furthermore possible to reduce the gas supply line in its cross section, whereby the entire airbag module can be smaller and more compact.

### BRIEF DESCRIPTION OF THE DRAWINGS

FIG. 1 is a gas supply line according to a first embodiment of the invention.

FIG. 2 is a cross sectional view of the gas supply line of FIG. 1 along line 2-2 of FIG. 1.

FIG. 3 is a cross sectional view of the gas supply line of FIG. 1 along line 3-3 of FIG. 1.

FIG. 4 is a cross sectional view of the gas supply line of FIG. 1 along line 4-4 of FIG. 1.

FIG. 5 shows a gas supply device according to a preferred embodiment of the invention.

FIG. 6 is a longitudinal section of the gas supply device.

FIG. 7 is a cross sectional view of the gas supply device according to FIG. 5 along lines 7-7 of FIGS. 5 and 6.

FIG. 8 is a cross sectional view of the gas supply device along according to FIG. 5 along lines 8-8 of FIGS. 5 and 6.

FIG. 9 is a cross sectional view of the gas supply device according to FIG. 5 along lines 9-9 FIGS. 5 and 6.

FIG. 10 is a diagrammatic representation of a filter effect in the gas supply line.

### DETAILED DESCRIPTION OF THE INVENTION

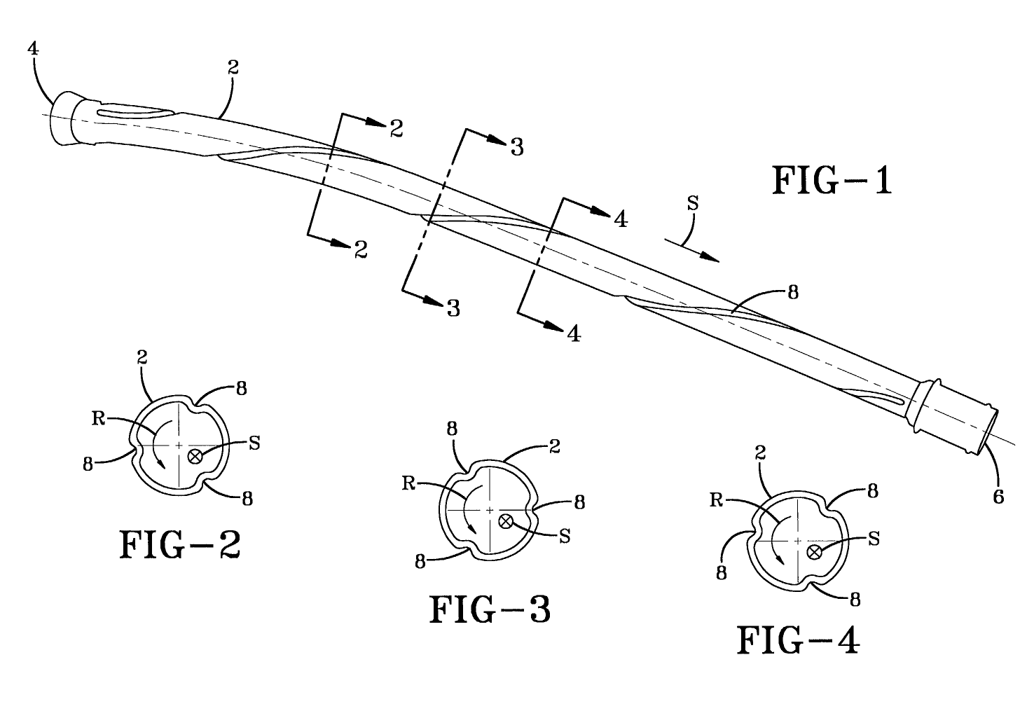

FIG. 1 shows a first embodiment of the gas supply line 2 according to the invention. The gas supply line 2 is essentially hose or tube shaped, preferably with an essentially circular cross section. However; the gas supply line may have any suitable cross section shape such as an oval. A first end 4 of the gas supply line 2 can be connected to a source of inflation gas, such as a gas generator, stored gas inflator or hybrid inflator, which is not illustrated in FIG. 1. The second end 6 of the gas supply line 2 can be connected to an airbag, which is not illustrated in FIG. 1. The ends 4, 6 of the gas supply line are connecting pieces, which can be secured to an airbag or a gas generator by clamps, for instance. Alternatively, this fastening can be made by other suitable joining processes, for instance by soldering, welding, gluing, screwing, injection molding, or the like. A spiral-shaped indentation and an associated ridge 8 extend over the entire length of the gas supply line 2. This indentation and the associated ridge 8 pointed inwardly on the outer side and on the inner side of the gas supply line 2. The spiral-shaped ridge extends over the entire length of the gas supply line 2 in a screw-shaped manner.

The gas supply line 2 can be made of metal, for instance. The gas supply line 2 is, however, preferably made out of synthetic material, for instance by blow molding. In this manufacturing procedure, it is easy to create as many spiral-shaped ridges 8 as desired for the directing and guiding of the gas flow in the inside of the gas supply line 2. The gas supply line, which has been optimized with regard to flow, thus enables a rapid and low resistance gas supply from the gas generator to an airbag.

In this embodiment the ridge follows a spiral-shaped path on the inner side of the gas supply line, in the manner of a screw thread. The incline or division of this spiral-shaped path can be adjusted in such a way that a desired twist is created. The more drawn-out the spiral, i.e. the larger the incline, the lower the twist of a flow in the gas supply line is. Depending on the length of the gas supply line, the ridge can form a plurality of complete paths in the gas supply line or extend along merely part of the circumference on the inner side of the gas supply line. The ridge can be continuous or in sections on the inner side of the gas supply line, so that a type of guide vane is created.

When gas from a source of inflation gas passes into the first end 4 in the gas supply line 2 the gas flows through the gas supply line 2 in a flow direction S. The ridge 8 on the inner wall creates a twist or a rotation in the gas flow, i.e. in the flow direction S. The gas flow runs along the spiral-shaped ridge 8. In this way a very even and preferably laminar flow with only little resistance and less turbulence is achieved such that the flow is made to rotate along the wall. In this way a twist is created in the flow in the gas supply line, which improves the flow relations in such a way that an increased gas flow rate is achieved through the gas supply line.

FIGS. 2 to 4 show cross sections along lines 2-2, 3-3 and 4-4 of FIG. 1. In these cross sections the gas supply line 2 has an essentially circular cross section. Inwardly pointing indentations and associated ridges 8 in the wall of the gas supply line 2 guide or direct the gas flow. Due to the spiral-shaped course of the ridges 8, a twist or a rotation of the flow is created in the direction of rotation R. In the present embodiment, the spiral-shaped ridges 8 in the flow direction S run in a counter-clockwise manner, so that the rotation direction of rotation R also runs counter-clockwise. The path of the ridge 8 can, however, alternatively run in the opposite direction, i.e. clockwise, so that a twist or a rotation of the gas flow is created in the clockwise direction. Whereas FIG. 1 shows only one spiral-shaped ridge 8, which winds itself several times around the gas supply line 2 over the entire length of the latter, in FIGS. 2 to 4 three ridges 8 are shown in the wall of the gas supply line 2. In these embodiments, three wound, spiral-shaped ridges 8 extend over the entire length of the gas supply line 2. The three ridges 8 in this embodiment preferably run essentially parallel to each other, i.e. the spirals defined by them have the same inclines. Through the arrangement of a plurality of ridges, that is to say two or more ridges on the inside of the gas supply line 2, an even more improved guiding or directing of the flow can be achieved.

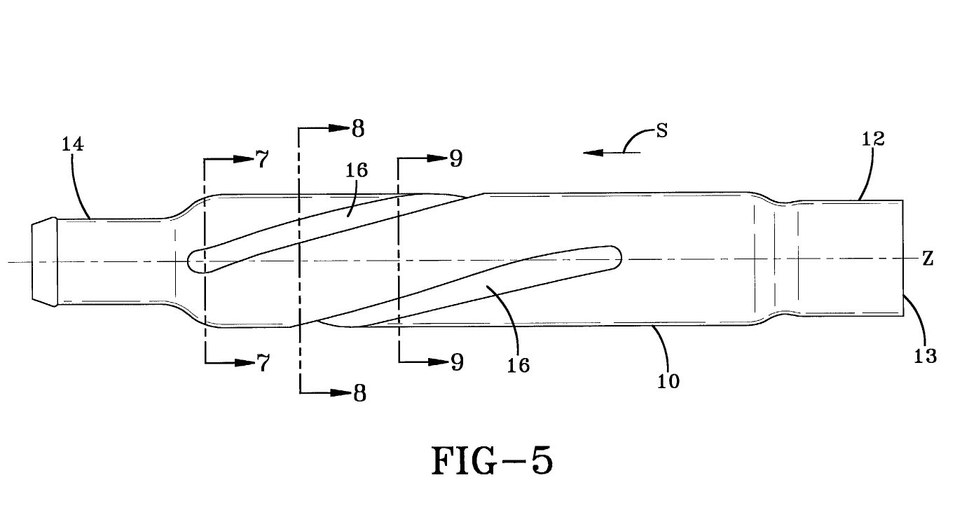

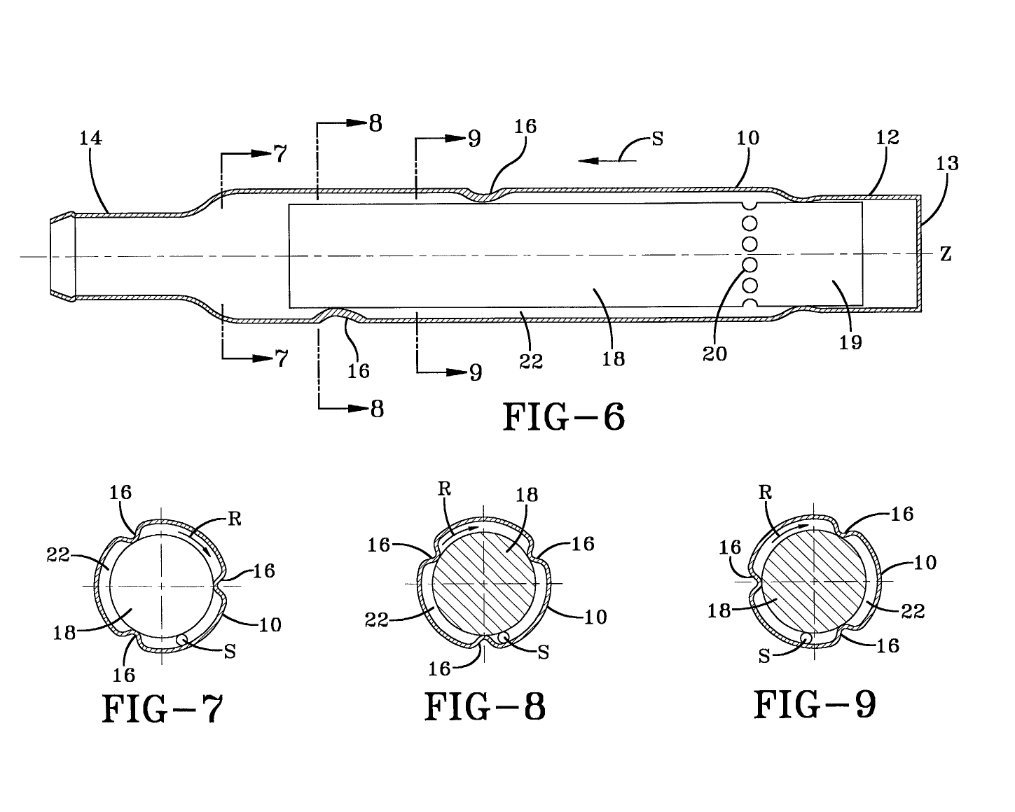

FIG. 5 shows an alternative embodiment of a gas supply line device to the invention. In this embodiment the gas supply line is an outer housing 10 for a source of inflation gas, such as a gas generator. The housing is essentially tube-shaped and preferably has a circular cross section, however other cross section shapes may be used. A first end 12 of the housing 10 is closed at a longitudinal side 13. The first end 12 of the housing is tapered, in order to clamp a gas generator inside the housing, as shown in FIG. 6. The second, opposite end 14 of the housing 10 is open. The second end 14 is also tapered and has the shape of a connecting piece for connecting with a gas supply hose, which the gas supply device connects to an airbag according to FIG. 5. On the outer side of the housing 10, in its middle region, are indentations or groove-shaped recesses 16. These indentations form ridges, which point inwardly and form corresponding ridges on the inner side of the housing 10. The groove or indentation and the associated ridge 16 extend in an essentially spiral-shaped manner in the flow direction S along the housing 10. A plurality of grooves or indentations and associated ridges 16 are foreseen, which extend essentially parallel to each other. The grooves or indentations and the associated ridges 16 in each embodiment do not perform a complete rotation around the housing 10, but extend along merely part of the circumference. The strength of the twist created in the flow depends on the magnitude of the inclination of the grooves or indentations and the associated ridges 16 with regard to the longitudinal axis Z of the housing 10. The lower the incline of the spiral-shaped grooves or indentations and the associated ridges 16, the stronger the created twist in the inside of the housing 10. The housing 10 is preferably be made of metal, but can also be made of synthetic material.

FIG. 6 shows a longitudinal section through a gas supply device according to FIG. 5. On the inside of the housing 10 a gas generator 18 is arranged. The gas generator 18 has an oblong shape and has a cross section that essentially corresponds to that of the housing 10, whereby the gas generator 18 has a smaller cross section. The gas generator 18 preferably also has a circular cross section. A first end 19 of the gas generator 18 is secured in the housing 10 in the region of the first end 12 of the housing, preferably by clamping. Close to the first end 19 of the gas generator 18, the latter comprises radially pointing gas escape openings 20. Between the outer wall of the gas generator 18 and the inner wall of the housing 10, a gas flow passage 22 is formed. The spiral-shaped ridges ridges 16 project into the flow passage 22. If the gas generator 18 is activated, gas flows from the gas escape openings 20 of the gas generator 18 into the flow passage 22 where the gas flow is diverted and flows in the flow direction S. Due to the spiral-shaped ridges 16, which extend in the flow passage 22, the initially linear flow of the gas is made to rotate, i.e. it undergoes a twist. The twisting gas flow continues to flow through the housing 10 and through the end 14 of the housing into a further gas supply line or a gas supply hose, which is not represented, which connects the gas supply device to an airbag. This arrangement favors a rapid flow of gas into the flow passage between the outer wall of the gas generator and the inner side of the gas supply line. Furthermore an escape of the gas out of the source of inflation gas in the latter's longitudinal direction is avoided, which would cause an undesired acceleration of the source of inflation gas in a linear direction due to the rapidly escaping gas can be avoided. It is particularly preferred that a plurality of gas escape openings are evenly distributed over the circumference of the gas generator, so that the forces of the escaping gas can counterbalance each other.

In the embodiment shown here, the ridges 16 of the housing 10 extend to the outer wall of the gas generator 18. The height of the ridges 16 can, however, be shorter, so the ridges do not to extend to the outer wall of the gas generator 18. Alternatively or additionally, spiral-shaped ridges can also be on the outer wall of the gas generator 18. Other flow-directing means can also be arranged in the flow passage 22, creating a twist in the gas flow.

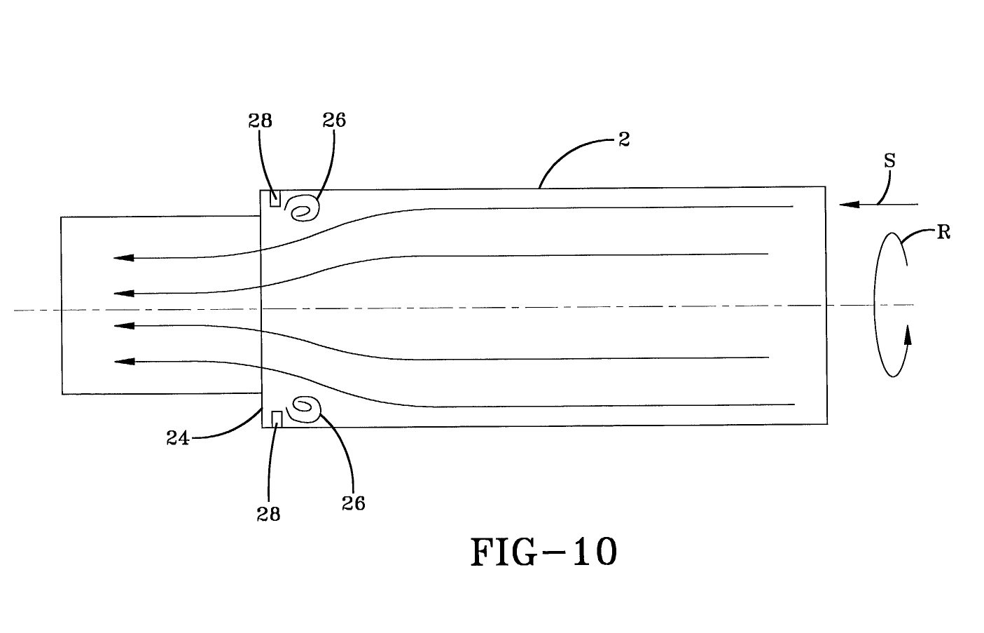

FIGS. 7 to 9 show cross sections along lines 7-7, 8-8 and 9-9 of FIGS. 5 and 6. The housing 10 and the gas generator 18 both have an essentially circular cross section, whereby the diameter of the gas generator 18 is smaller. In this way, between the inner wall of the housing 10 and the outer wall of the gas generator 18, an annular flow passage or flow channel 22 is defined. The ridges 16 extend into this flow passage 22. In this embodiment, three spiral-shaped grooves and the associated ridges 16 are provided, as shown in FIG. 5. A smaller or larger number of grooves or indentations and associated ridges, however, can be foreseen, which extend at least in sections over the length of the housing 10. On the basis of the flow direction S from the first end 12 to the second end 14 of the housing and the direction of the spiral-shaped paths of the grooves or indentations and the associated ridges 16, in the present embodiment a twist with an counterclockwise rotation direction of rotation R is achieved. The paths of the spiral-shaped grooves and the associated ridges 16 can, however, also run in the opposite direction, so that a twist is achieved in the clock-wise direction. In this flow passage, at least one flow-directing ridge is arranged in such a manner, that a twist is created in the linear flow, i.e. the flow moves through the gas supply line in a rotating manner in the longitudinal direction of the gas supply line with regards to its inner wall. This twist or this rotation of the flow improves the efficiency of the gas supply, since a preferred laminar flow with less turbulence can be created. The entire flow takes place with little resistance, so that a more rapid inflation of the airbag with gas can be achieved.

FIG. 10 is a diagrammatic representation of how a filter effect can be achieved by the gas supply line 2 according to the invention. In this embodiment particles can be partitioned from the gas and kept back, so that the particles cannot enter the airbag. In the gas supply line 2, as described above, flow-directing ridges, not shown in FIG. 10, are arranged, which ensure that in the flow S a twist is created in the direction of rotation R around the longitudinal axis of the gas supply line 2. In the gas supply line a step or cross section narrowing 24 is foreseen. This step-shaped cross section narrowing 24 forms corners or angles wherein a dead space or t urbulences 26 are created. The particles 28 move in the rotating flow on the basis of their increased mass and of the centrifugal force acting upon them along the inner side of the gas supply line 2. When they reach the step 24, the particles do not enter the narrowed tube region, instead they are collected and kept back on the step 24 in the dead space 26. Due to this particle interception, the flow resistance of the gas flow is further reduced, since the friction of the gas flow caused by the particles can be reduced or eliminated. Friction losses in the flow are thus minimized.

In the shown embodiments, the flow-directing or flow-guiding ridges 16, corresponding to the ridges 8 in FIGS. 1 to 4, are created by grooves of the wall of the gas supply line. Alternatively, however, solid ridges on the inner side of the wall can also be provided by suitable manufacturing methods.

In a further preferred embodiment, at least in one section of the gas supply line wherein a flow-directing ridge is foreseen, a source of inflation gas can be arranged in such a manner that it extends in the longitudinal direction of the gas supply line, a gas escape opening is arranged at a back end of the source of inflation gas as seen from the flow direction, and between an outer wall of the source of inflation gas and the inner side of the gas supply line a flow passage is defined wherein the flow-directing ridge extends. In this arrangement the gas flows out of the back end of the source of inflation gas as seen from the flow direction and then flows parallel to the outer wall of the source of inflation gas along the latter. It flows through an annular flow channel, which is defined between the outer wall of the source of inflation gas and the inner side of the gas supply line. Since in this flow channel, the flow-directing ridge is arranged on the inner side of the gas supply line, the gas flowing in the longitudinal direction through the gas supply line is made to rotate, i.e. it is given a twist. This twist improves, as described above, the flow relations in such a manner that a more rapid flow and lower flow resistance can be created in the gas supply line. The arrangement of the oblong gas generator, which is preferably circular in cross section, within the gas supply line enables a very compact configuration of an entire airbag module. The flow-directing element is preferably at least one spiral-shaped ridge on the inner side of the gas supply line and/or the outer side of the gas generator. The ridge enables a simple creation of a flow-directing element, preferably integral or one piece with the inner wall of the gas supply line and/or the outer wall of the gas generator.

The gas supply tube or housing of the invention is advantageously employed in a side curtain airbag module. In a curtain airbag module of this type, the configuration of the gas generator according to the invention is particularly advantageous. In airbag modules of this type, the gas generator is generally arranged at a distance from the airbag and it is desirable that the gas generated by the gas generator is introduced into the airbag as rapidly as possible.

From the foregoing, it will be apparent to those skilled in the art that modifications may be made without departing from the spirit and scope of the invention. Accordingly, the invention is not intended to be limited except as may be made necessary by the appended claims.

1. A gas supply line for connecting a source of inflation gas to an airbag, located inside of the gas supply line is at least one flow-directing element that imparts a twist in a linear flow of gas through the gas supply line.

2. The gas supply line according to claim 1 wherein the at least one flow directing element comprises at least one ridge on an interior wall of the gas supply line extending in the longitudinal direction of the gas supply line along a spiral-shaped path.

3. The gas supply line according to claim 2 wherein the ridge is formed by an indentation in an outer wall of the gas supply line.

4. The gas supply line according to claim 1 wherein the at least one flow directing element comprises a plurality of ridges on an interior wall of the gas supply line extending in the longitudinal direction of the gas supply line along a spiral-shaped path.

5. The gas supply line according to claim 4 wherein the ridges are formed by indentations in an outer wall of the gas supply line.

6. The gas supply line according to claim 1 wherein the at least one flow directing element comprises a plurality of ridges on an interior wall of the gas supply line extending parallel to each other in the longitudinal direction of the gas supply line along spiral-shaped paths.

7. The gas supply line according to claim 6 wherein the ridges are formed by indentations in an outer wall of the gas supply line.

8. The gas supply line according to claim 1 wherein a source of inflation gas is located inside of the gas supply line.

9. The gas supply line according to claim 2 wherein a source of inflation gas is located inside of the gas supply line.

10. The gas supply line according to claim 3 wherein a source of inflation gas is located inside of the gas supply line.

11. The gas supply line according to claim 4 wherein a source of inflation gas is located inside of the gas supply line.

12. The gas supply line according to claim 5 wherein a source of inflation gas is located inside of the gas supply line.

13. The gas supply line according to claim 6 wherein a source of inflation gas is located inside of the gas supply line.

14. The gas supply line according to claim 7 wherein a source of inflation gas is located inside of the gas supply line.
